(19) United States
(12) Patent Application Publication
(10) Pub. No.: US 2003/0191781 A1
(43) Pub. Date: Oct. 9, 2003

(54) Directory-based service activation system and method

(76) Inventors: Seyhan Civanlar, Red Bank, NJ (US); Ryan Delacy Moats III, Omaha, NE (US); Christopher Robert Jiras, New York, NY (US)

Correspondence Address: MICHAEL I CHAKANSKY, SILLS CUMMIS RADIN TISCHMAN EPSTEIN, AND GROSS, ONE RIVERFRONT PLAZA, NEWARK, NJ, 071025400

(21) Appl. No.: 10/348,085

(22) Filed: Jan. 21, 2003

Related U.S. Application Data
(60) Provisional application No. 60/369,772, filed on Apr. 3, 2002.

(51) Int. Cl. G06F 17/00

(52) U.S. Cl. 707/200

(57) ABSTRACT

A directory-based service activation system and method for automatically updating, in relatively real time, information regarding a variable in an appliance running an agent forming a client of a TCP/IP protocol, while maintaining the pre-update state of the variable at least until the update is successful.

### CROSS-REFERENCE TO RELATED APPLICATIONS

This application claims priority from U.S. Provisional Application Ser. No. 60/369,772, filed Apr. 3, 2002, the disclosure of which is incorporated herein by reference. A portion of the disclosure of this patent document contains material which is subject to copyright protection. The copyright owner has no objection to the facsimile reproduction by anyone of the patent disclosure, as it appears in the Patent and Trademark Office public patent files or records, but otherwise reserves all copyright rights whatsoever.

### BACKGROUND OF THE INVENTION

The present invention relates to configuring and activating complex IP-based services such as Voice over IP (VoIP), Virtual Private Network (VPN) and Video on Demand (VoD) on a telecommunications network running the TCP/IP protocol using, in one preferred embodiment, a Lightweight Directory Access Protocol (LDAP) directory to store a model of all the service parameters and network settings.

Activation (also known as provisioning) of services plays an important role in a complex network such as the Internet. Activation refers to altering settings in a network equipment or server. Adding a new network device may also be considered being part of activation. Activating different IP-based services and network equipment using disparate systems with different databases and client interfaces is not efficient. In an environment where subscribers desire multiple Internet services (IP telephony, Email, IP access, etc.), where common subscriber credentials are required (e.g., name, address, credit card number, email address, username, password, etc.) for bill generation and user authentication, using a single system, which delivers a coordinated activation of all these services and that eliminates the duplication of customer information in many disjointed systems and databases is desirable. By using a single Directory, such as an LDAP directory, to store all the subscriber account and authentication information, the present invention can reduce or eliminate many of these problems.

A directory is a data store that has been optimized for millions of reads; when applied to problems that require far fewer writes as compared to reads, directories are known to provide significant performance advantages compared to Databases. Historically, the most popular implementations of directories have been corporate organizational directories where millions of searches are typical and in white/yellow page applications supporting user authentication/authorization/accounting (AAA) functions.

Recognizing the power of directories, in the early 1990s, the Internet Engineering Task Force (IETF) standardized a simplified directory access protocol, LDAP (RFC 1777, 2251-2256, 2829, and 2830). This protocol makes use of the TCP/IP protocol stack and provides only the most needed functions of the far more complex X.500 directory access protocol. Thus, LDAP directories are easily incorporated into an IP network since LDAP is an IP protocol.

Early implementations of LDAP-enabled IP applications were IP address, Dynamic Host Configuration Protocol (DHCP) and Domain Name Services (DNS) and AAA functions for remote access and VPN services. The IETF is defining additional functionality such as “replication” that supports heterogeneous distributed directory implementations. With these protocol extensions, changes will be replicated between many remote LDAP servers without clients having to perform any extra operations to request replication of data. A replication is typically performed between a primary (or master) directory and a secondary (or slave) directory, which stores a replica of the information in the primary directory for extra reliability. Using replication, a secondary directory receives changes to the data entries in the primary directory and updates its data to ensure both Directories are in synch.

The IETF's Policy Networking initiative has defined a policy-based framework (RFC 3060), also known as Directory Enabled Networking (DEN) that enables directories to be applied to more complex network provisioning tasks. Policies promise simple expressions of complex tasks (such as firewall or VPN configuration).

Despite the significant progress in directory technology, several major drawbacks became impediments for more aggressive directory-based network provisioning deployments. The first drawback is the “passive” nature of a directory; it only responds to queries (also known as “pull” action). This specific problem may seem like a non-issue for devices that only use directories at startup and so only need to pull data once. However, in a more complicated service management scenario where a user changes the service parameters by altering data elements stored in the directory, there is no inherent directory synchronization mechanism to recognize the change in the data element and autonomously reconfigure appropriate devices. It is possible for the network equipment to periodically pull the data pertinent to configuration of the equipment from the LDAP directory, and if the data is different than the configuration settings in the equipment to change it to ensure the configuration data in the LDAP directory and network equipment are identical. Despite its simplicity, this approach does not scale well in large-scale network implementations applicable to telecommunications service provider networks where there are thousands of pieces of network equipment. In accordance with a preferred embodiment of the present invention, a more optimized solution is to build a mechanism that detects changes in the data stored in the directory that represents device or server settings, and pushes the data into the appropriate equipment only when there is a change.

The second shortcoming in using directories for network provisioning occurs when a service or network provisioning action requires multiple network touch points (a Customer Premises Equipment such as a cable modem, several routers, etc.) to complete the new configuration. This scenario requires additional capabilities to handle transactions and to coordinate successful completion of multiple tasks. While directories do support the concept of atomicity of changes to a single entry stored within the directory, the atomicity of multi-entry changes (i.e. transactions) is the responsibility of clients. Meaning, there is no logic inherent in the directory that enables successful execution of multiple changes in the network. Multi-entry changes are typically needed for the completion of a service change that requires configuration modifications in multiple pieces of equipment (e.g. a cable modem and a cable modem termination system (CMTS)) simultaneously.

U.S. Pat. No. 6,247,017 ('017 patent) discloses a computer implemented method of updating a local record of a variable in an appliance comprising a directory user agent forming a client of a directory service on a telecommunications network. FIG. 8 is similar to the prior art figure given in the '017 patent, while FIG. 9 is similar one of the '017 figures related to the schematic representation of the message exchange for an embodiment of the '017 patent. The '017 patent method includes the steps of, at the network element, receiving a replication message from the directory service in respect to a change to the variable, and then responding to the replication message to update the local record of the variable. Moreover, in the '017 patent, and in FIG. 8 and FIG. 9, if the client update fails, there is no recovery process defined. That is, the client and directory service will be out of synchronization with respect to the value of the variable because the directory service will contain the updated data and can not fall back.

### SUMMARY OF THE INVENTION

The present invention relates to configuring and activating complex IP-based services on a telecommunications network running the TCP/IP protocol using a LDAP directory to store a model of all the service parameters and network settings. According to an aspect of the present invention, the system synchronizes the IP network with the LDAP directory using an efficient and scalable method making directories suitable for provisioning services on an IP service provider's network which contains thousands of devices. The IP network device (“device” or “network device”) represents network equipment such as routers and switches, customer premises equipment (CPE), such as cable modems and fire-walls, network element management systems, servers such as email and web hosting servers, and Operating Support Systems (OSS), all running the TCP/IP.

As noted above, directory services, such as those disclosed in the '017 patent, or described in FIGS. 8 and 9, have no inherent memory and can not store the value of a variable before and after an update; an update is a write action on the directory. An embodiment of the present invention remedies this problem by using the LDAP replication protocol in both forward and reverse directions between two LDAP servers. See FIG. 10. The forward direction replication transmits the update to the directory-based service activation method and system (DAS) of the present invention, the reverse direction replication updates the primary directory service with the old value. DAS has the ability to store the updated value as well as the value before an update to ensure the primary directory server can be synchronized to the client if the update fails.

DAS, a modified directory server also known as the Change Detector, runs outside the client, upon receipt of a replication message from the primary/master directory service, transmits the message to the client application running in the appliance using any protocol compatible with TCP/IP, such as LDAP, CLI, SNMP or SSH protocol, while maintaining the state of local client implementation along with the ability to recover to the state before the update. Thus in the case of a problem with the update, DAS can use the replication protocol to update the primary directory server with the state before update.

DAS enables a user to change the settings of a plurality of his/her IP services by only changing attributes of one or more entries stored in a LDAP directory where the entries model IP services, and/or one or more IP devices. The DAS service receives a replication message of entry changes from the primary LDAP directory using the LDAP replication protocol and “pushes” the changes into the network devices to synchronize the IP network with LDAP directory, thereby, generally, eliminating the need for the network equipment to periodically poll the LDAP directory to receive and implement changes. A plurality of network devices receive the updates from the DAS where DAS coordinates successful execution of all changes, and the synchronization with the LDAP directory under both success and failure scenarios of physical networks changes.

One preferred embodiment of the present invention is a directory-based service activation system for automatically updating, in relatively real time, information regarding a variable in an appliance running an agent forming a client of a TCP/IP protocol, while maintaining the pre-update state of the variable at least until the update is successful. The system receives a replication message from a primary directory that the information has been updated and stores store both the pre-update and the updated variable information for the appliance. The system then implements an update of the variable in the appliance, while maintaining the state of implementation of the variable update in the appliance. Finally, if the appliance update is unsuccessful, the system restores the pre-update variable value in said primary directory, using a replication message sent to said primary directory, and provides an error message to other systems.

### BRIEF DESCRIPTION OF THE DRAWINGS

FIG. 1 is a block diagram of one preferred embodiment of the directory-based service activation system and method of the present invention. P-LDAP refers to a primary directory, while S-LDAP refers to a secondary directory.

FIG. 2 is a diagram illustrating data state changes between various components of an embodiment of the system and method.

FIG. 3 is a detailed version of FIG. 1 showing various components of the system and method and their interfaces.

FIG. 4 is a block diagram of an embodiment of the Change Detector of the present invention, illustrating its interfaces.

FIG. 5 is a block diagram of an embodiment of the Activation Engine of the present invention, illustrating its interfaces.

FIG. 6 is a block diagram of an embodiment of the Device Driver of the present invention, illustrating the touch points to multiple network equipment and servers.

FIG. 7 is an exemplary detailed implementation of the directory-based service activation system and method of the present invention using Java based protocols, patterns and interfaces.

FIG. 8 is a schematic representation of one prior art method for updating an appliance using a directory.

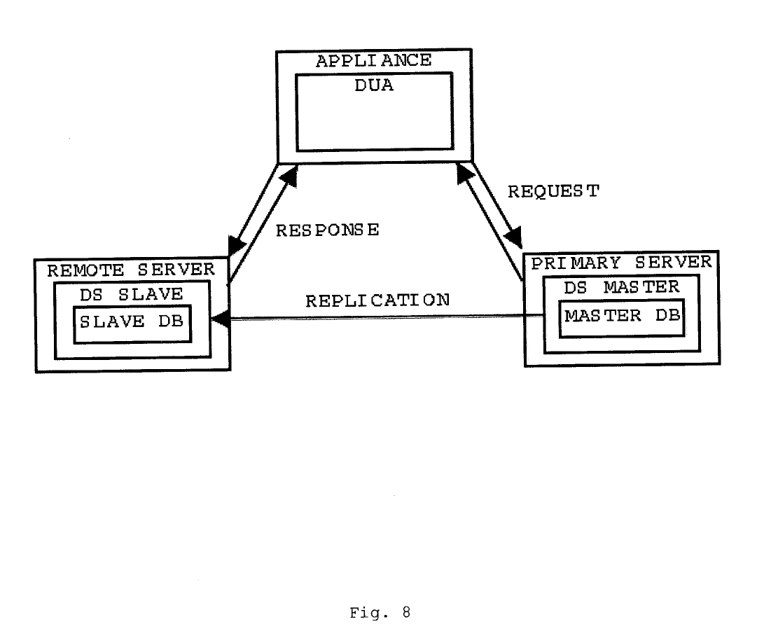

FIG. 9 is a schematic representation of another method for updating an appliance using a directory.

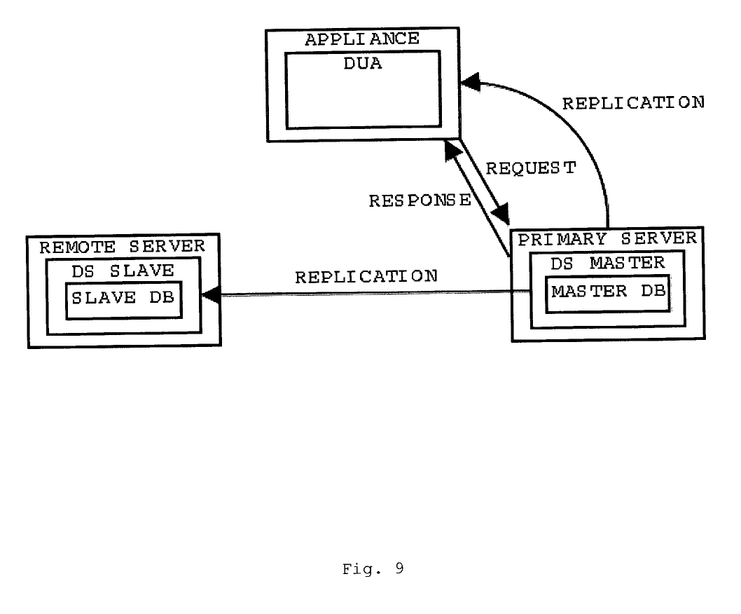

FIG. 10 is a schematic representation of an embodiment of the present invention for updating an appliance using a directory.

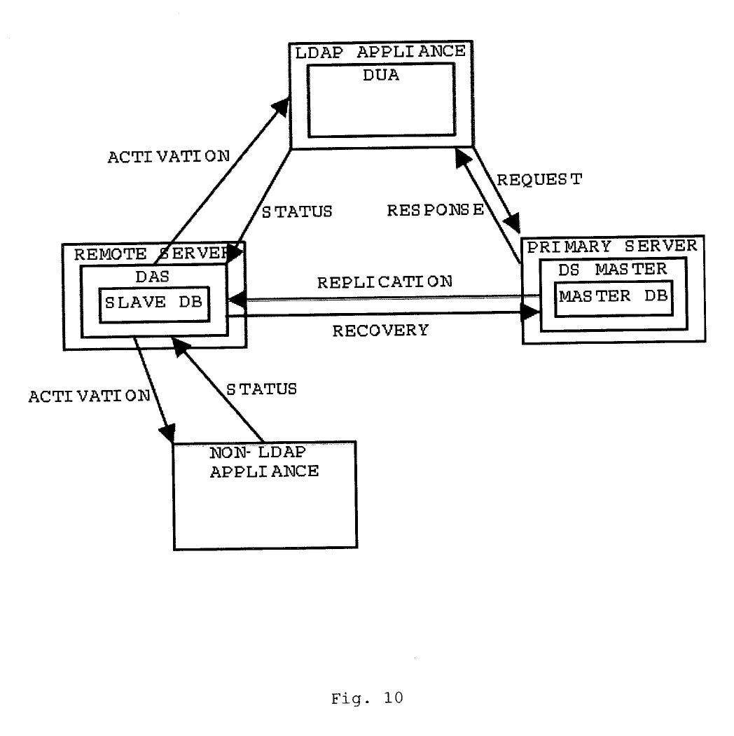

### DETAILED DESCRIPTION

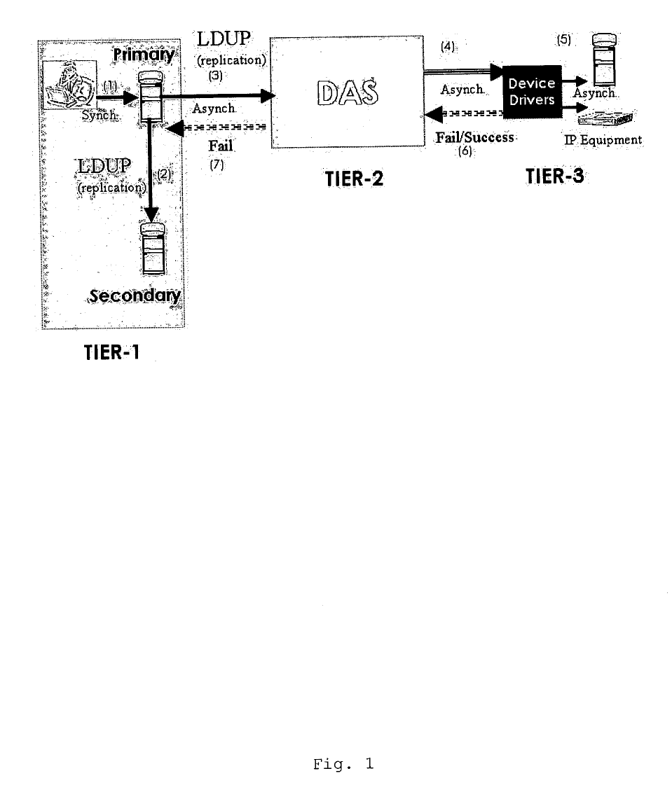

DAS breaks down the service activation process into three tiers as illustrated in FIG. 1. The goal of the creating multiple tiers is to eliminate the need for an end-to-end synchronous process which starts when a service change request comes from a client application such as a browser and ends when the change is implemented on the IP network, returning a successful message to the customer. Although a synchronous process is the most straightforward implementation, it does not scale well. Breaking down the process into tiers allows asynchronous signaling to be used where it optimizes scalability and performance.

In the first tier of the process (FIG. 1, TIER-1, steps (1) and (2)), a user (or subscriber) uses the web browser to access a URL in which an interface to primary directory is implemented. The user requests changes to the service (e.g., changes the 3DES encryption key for a VPN tunnel). The requested change causes a change in a data entry within the primary directory (e.g., the 3DesKey data entry associated with the user's tunnel) and through the replication protocol, it gets relatively instantaneously replicated in the secondary directory. This step creates an illusion of a successful physical implementation of the service change onto the IP network, although service changes have not yet been implemented. That is, the data in the primary directory which models the service settings (e.g., new 3DesKey) and the actual service settings on the IP network (e.g., the 3DesKey stored within the router) are out of sync. Tier-1 is a synchronous process.

Next the data changes which arise from a user's IP service setting changes (FIG. 1, TIER-2, step (3)), are implemented in another secondary directory which is an integral part of DAS. The difference between DAS as a secondary LDAP directory and a standard secondary LDAP directory is that DAS maintains old data, as well as new data, simultaneously. A typical secondary directory immediately overwrites the old data with the new data upon a replication request from the primary LDAP server.

After appropriate filtering of data changes and retrieving additional data from the LDAP primary directory associated with the physical devices impacted by the service change, DAS sends the needed service changes to the actual device drivers which in turn implements the service changes onto the actual physical devices. FIG. 1, steps (4) and (5). The interface between DAS and the device drivers is an Application Programming Interface (API). If the process in Tier-3 fails, a message is sent back to Tier-2, which swaps the new data with the old data. In turn, Tier-2 updates the LDAP primary directory data with the stored old data and creates a message for the user to create an error log. If the process succeeds, the DAS discards the old data that was kept temporarily until full synchronization is obtained between the data and the network. See FIG. 1, TIER-3, steps (4), (5), (6) and (7).

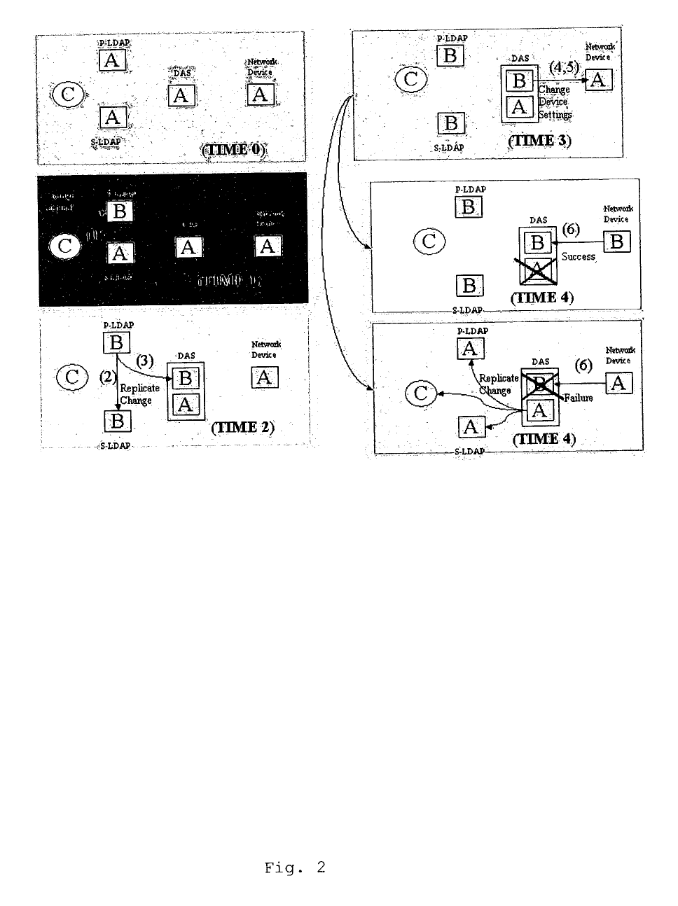

FIG. 2 illustrates the data propagation steps during the service change process.

At initial time, TIME 0, primary LDAP (p-LDAP), secondary LDAP (s-LDAP), DAS and the Network Device are in synch and contain data entry value “A”. FIG. 2.

At TIME 1, user sends a service change request, which translates into changing the corresponding data entry in the LDAP directory from value “A” to “B”. At TIME 1, the s-LDAP, DAS and network device are out of synch with p-LDAP. FIG. 2.

At TIME 2, p-LDAP “replicates” data entry “B” onto s-LDAP and DAS simultaneously. S-LDAP swaps “A” with “B”, while DAS stores both “B” (as new) and “A” (as old) data. FIG. 2.

At TIME 3, DAS pushes the data entry “B” onto the network device(s). There are two possible outcomes shown in FIG. 2 as TIME-4.

If the change is executed on the device, DAS swaps “A” with “B” and discards “A”. At this time, all the components of the system are in synch as they all contain the new value “B”. If the change is not successfully executed, DAS swaps “B” with “A”, and (1) sends a replication message to p-LDAP and s-LDAP to set the data entry value to “A”, and (2) creates an error message for the user.

Changes are executed into the primary and secondary directories prior to the corresponding physical activation actions that will take place in IP equipment and servers only those activations that fail require going back and synchronizing data values between the directory and IP equipment/servers and messaging the user about the failure of the activation action. The underlying assumption of one preferred embodiment's architecture is that more than 90% of all service activation requests will succeed. This assumption allows for the design of the embodiment to be optimized. Thus, the data synchronization issue between the model representation in the form of data elements in the directory and the physical representations in the devices needs only be handled as an exception.

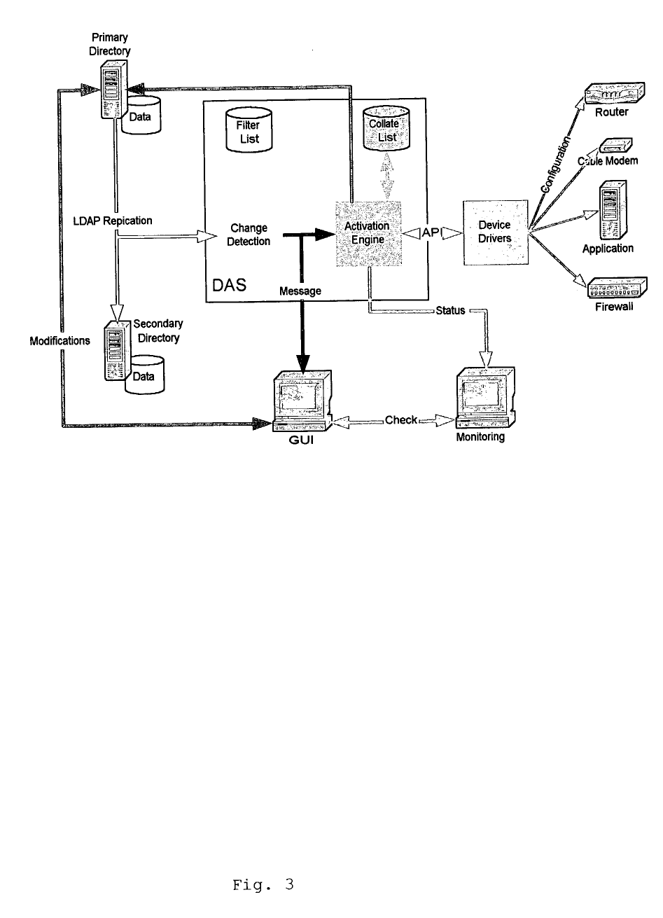

As shown in FIG. 3, DAS has several important key components, including: Change Detector and Activation Engine. These two components can leverage directory technology and special schema elements such as filter list and collate list to ensure proper operations.

Change Detector

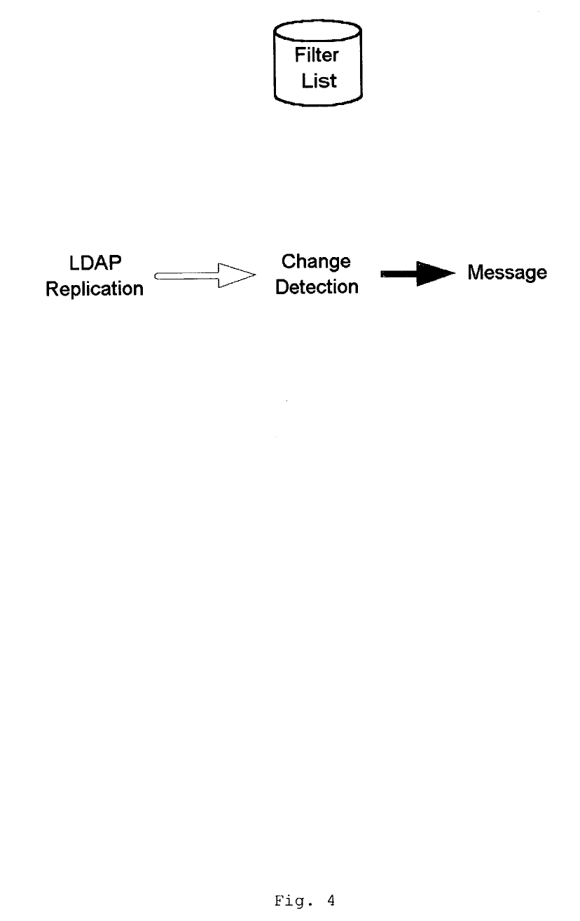

The Change Detector (FIG. 4) “watches” the replication stream from the primary directory. DAS does not require any modification to the primary LDAP directory. Thus an “off-the-shelf” directory can function as the primary LDAP, since the Change Detector looks like just another replication target (secondary LDAP directory). The difference between the Change Detector and a secondary LDAP directory is that while a replicating LDAP directory sends a series of changes, the Change Detector also includes the previous state of the entry. This provides the Activation Engine with the information it needs to resynchronize the directories in case a Device Driver signals a failure in configuration.

When a change occurs to a data element in the primary directory, the Change Detector module will see it via the replication stream. In one embodiment of the present invention, to avoid overloading the Activation Engine with trivial changes, the Change Detector uses a Filter List (which may be stored in the directory) to determine what changes are important. The filter list is an integral part of this preferred embodiment of the present invention and is based on the use of regular expressions to match values of important attributes of the entry (e.g., objectClass or distinguishedName). By using regular expression matching of any attribute of the entry being changed, it is possible to detect not only changes to a single entry but to detect changes across a structure that covers multiple entries (e.g. a policy tree). If there are changes in the directory that do not impact any IP network equipment or servers or other systems (such as Operating Support Systems (“OSS”)), then the change is ignored. Note that OSS is not separated out from IP network and servers as it will provide a TCP/IP connection to DAS.

If the filter list is itself stored in the directory, then it is possible to dynamically modify the behavior of the Change Detector by changing the filter list.

Activation Engine

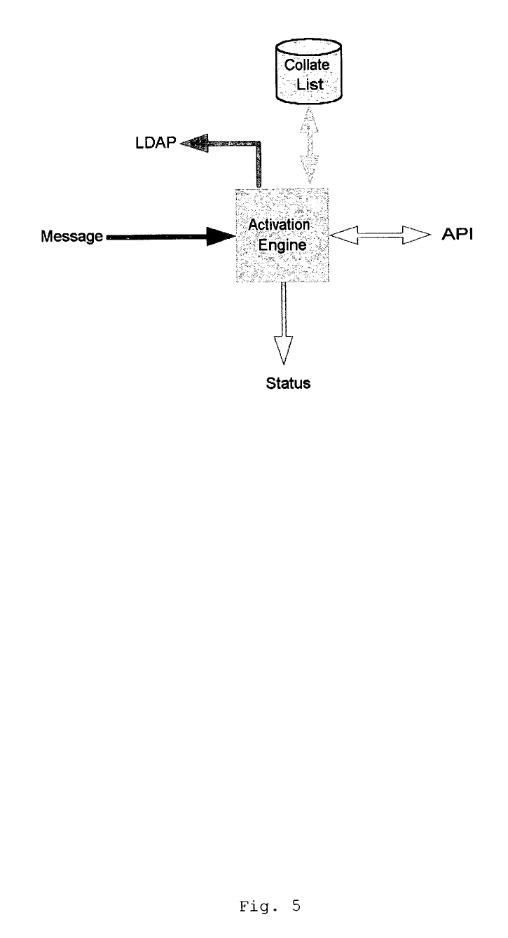

The Activation Engine (FIG. 5) accepts messages from the Change Detector and provides transaction support. The first stage of transaction support is provided via a “Collation List” that the Activation Engine applies to messages from the Change Detector to determine which sets of changes require which devices to be reconfigured. The Collation List (which may be stored in the DAS secondary directory, which is also known as the Change Detector) is a list of the changes that act as triggering mechanisms. These triggering mechanisms cover both the activation trigger (i.e., the change that leads to the Activation Engine selecting a Device Driver) and also the changes that act as “transaction delimiters” trigger. This second trigger notifies the Activation Engine that a series of changes should be collected together as a “transaction”. The Activation Engine (after checking that these changes are not the result of a restore operation) collects these changes, but does not connect to a Device Driver until the activation trigger for that transaction is received.

When the activation trigger is received, the Activation Engine calls the appropriate Device Driver(s) for configuration. If the configuration is successful, the set of changes is discarded. If the configuration fails and the Device Driver was able to restore the device to the previous configuration, the Activation Engine uses the set of changes to restore the primary directory to its previous state and to ensure that the resulting messages from the Change Detector are ignored. This prevents a never-ending activation loop.

As noted above, one preferred embodiment of the present invention employs a Collate List. The Collate List allows the Activation Engine to determine (a) does the modification trigger an event, (b) does a modification start a new batch of changes, (c) is this modification part of an existing batch, (d) does this modification terminate a batch and trigger on it. Regular expression matching of changes is also used in the Collate List, so that changes in the Collate List can include the modification of an attribute to a particular value, the addition or deletion of an attribute, or the addition or deletion of an entry. Further, the Collate List can be combined with the Filter List into a single data element, allowing both the Change Detector and the Activation Engine to be controlled together. Still further, if this data element is stored in the DAS secondary directory, it is possible to dynamically change the system behavior by changing the element in the directory.

The Activation Engine determines the correct device driver via a mapping from the “trigger” change and available devices. If this mapping is contained in a directory, the Activation Engine expects the following attributes to be used to store this information.

( 1.3.6.1.4.1.12002.1.6
NAME ‘lnTemplateType’
DESC ‘The template type to use

when configuring the object this
class models.’

SYNTAX

1.3.6.1.4.1.1466.115.121.1.15
SINGLE-VALUE

EQUALITY caseIgnoreMatch

)
(1.3.6.1.4.1.12002.1.166 NAME
‘lnFirmwareRevision’

DESC ‘The firmware revision

this system is using.’

SYNTAX

1.3.6.1.4.1.1466.115.121.1.15
SINGLE-VALUE

EQUALITY caseIgnoreMatch

)

Once the correct Device Driver is determined, the Activation Engine makes an API call to that Device Driver to configure the end device. When the Device Driver is finished, the Activation Engine examines the result code. If successful, the Activation Engine discards the stored changes and sends a successful status message to the monitoring system. If a failure has occurred and the Device Driver has returned the end device to its previous state, the Activation Engine uses the stored changes to resynchronize the primary directory and sends a failed status message to the monitoring system. Lastly, if a failure has occurred, but the end device could not be returned to its previous configuration, then the Activation Engine discards the changes and sends an alarm message to the monitoring system.

These messages to the monitoring system are the remaining interface of the Activation Engine. As stated above, this stream reports the status of device drivers so that this status is available to users via the management GUT.

One implementation of the Activation Engine uses J2EE, Enterprise Java Beans and Java Messaging Server (JMS).

Device Drivers

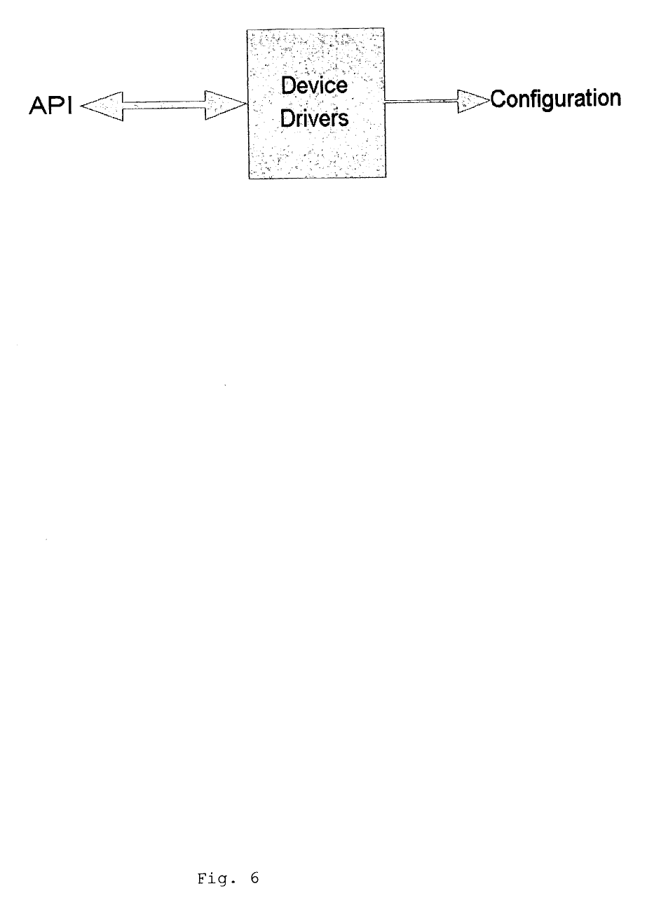

While not part of the DAS architecture proper, the Device Drivers (FIG. 6) are an important component. They receive information from the activation engine via an API call. They have responsibility for establishing a secure connection to the end device and performing the configuration, and returning the result to the Activation Engine.

Device Drivers use the following attribute from the [DAS secondary] directory to determine the communication method to use with the end device in question.

( 1.3.6.1.4.1.12002.1.1 NAME
‘lnCommunicationMethod’
DESC ‘The Communication Method to
use when configuring this system.’
SYNTAX
1.3.6.1.4.1.1466.115.121.1.15
SINGLE-VALUE
EQUALITY caseIgnoreMatch
)

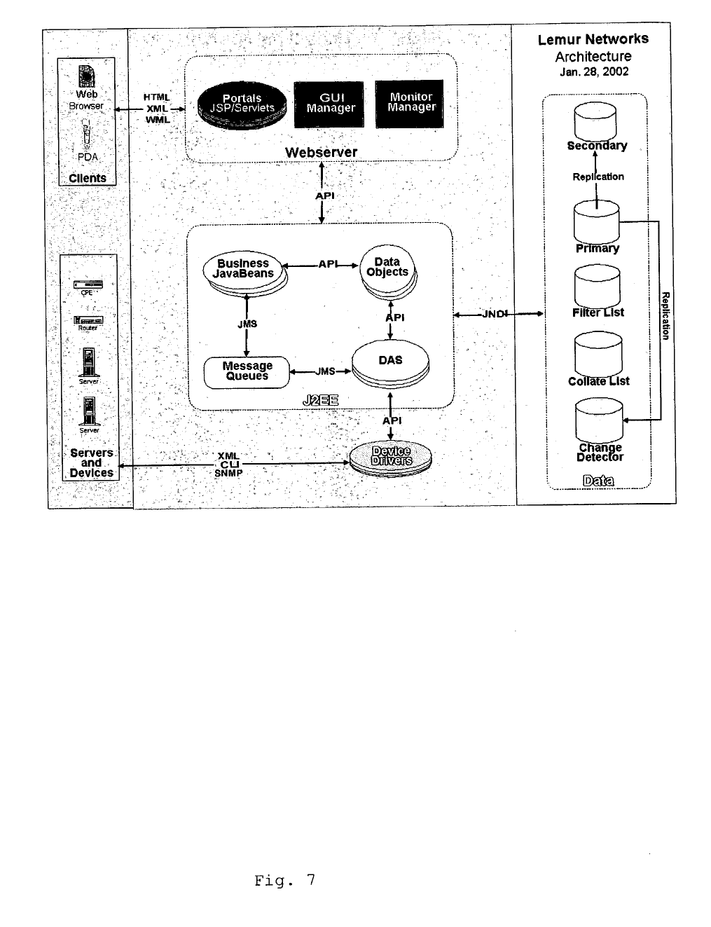

FIG. 7 illustrates a feasible physical implementation of the system of the present invention. The left hand side block shows the devices including the client, network equipment, servers and business partners, network and services interface. The center block shows the DAS, which includes the Change Detector, Activation Engine and Connector application code, and the various additional java components to handle message queuing and data flow, which connect to the presentation layer (center top) and the Device Drivers (center bottom) with open APIs. The Device Drivers in turn attach to the devices and run XML, CLI or SNMP protocols to execute service changes. The right hand side block shows the data components including primary directory, secondary directory, DAS secondary directory (which as noted early is also known as the Change Detector), Filter List and Collate List as components of the infrastructure.

Although preferred specific embodiments of the present invention have been described herein in detail, it is desired to emphasize that this has been for the purpose of illustrating and describing the invention, and should not be considered as necessarily limiting the invention, it being understood that many modifications, can be made by those skilled in the art while still practicing the invention claimed herein.

What is claimed is:

1. A passive data store based service activation system for configuring and activating network based clients, wherein the passive data store comprises:
means for receiving a replication message from a primary passive data store about an update to an original value stored in the primary passive data store;
means for determining whether the update needs to be communicated to a network based client;
means for communicating an update which needs to be updated to the client;
means for maintaining the original value;
means for maintaining the state of implementation of the update on the client;
means for updating the primary passive data store with the original value of the update if the implementation of said update on said client is unsuccessful.

2. The service activation system of claim 1, wherein communication to the client regarding the update is transmitted using a SNMP or a SSH protocol.

3. The service activation system of claim 1, wherein the passive data store is a directory.

4. The service activation system of claim 3, wherein the directory uses LDAP protocol.

5. The service activation system of claim 1, wherein the passive data store is a set of files.

6. The service activation system of claim 1, wherein there is a primary passive data store with a plurality of passive data stores each servicing a different group of clients.

7. The service activation system of claim 1, wherein the passive data store batch processes updates and sends a reverse update if multiple value updates fail, and maintains a single state for multiple value updates.

8. The service activation system of claim 1, wherein replication protocol is directory replication.

9. The service activation system of claim 8, wherein the directory replication is LDAP protocol.

10. The service activation system of claim 1, wherein a change detector is used to receive the replication message.

11. The service activation system of claim 10, wherein a filter list is used to determine whether the update needs to be communicated to a client.

12. The service activation system of claim 10, wherein an activation engine is used to accept messages from the change engine and provide transaction support.

13. The service activation system of claim 12, wherein the activation engine applies a collation list to messages from the change detector.

14. A passive data store based service activation method for configuring and activating network based clients, comprising the steps of the passive data store:
receives a replication message from a primary data store service about changing a value of a variable in a client;
maintains the original value and the changed value;
transmits the changed value in a message to the client;
checks to determine if the implementation in the client is successful;
if the implementation is not successful, uses the replication protocol to update the primary data store with the original.

15. The service activation method of claim 14, wherein the passive data store transmits the value in a message to the client using SNMP or SSH protocol.

16. A directory-based service activation system for automatically updating, in relatively real time, information regarding a variable in an appliance running an agent forming a client of a TCP/IP protocol, while maintaining the pre-update state of the variable at least until the update is successful, wherein the directory activation service system comprises:
means to receive a replication message from a directory that the information had been updated;
means to store both the pre-update and the updated variable information for the appliance;
means to implement an update of the variable in the appliance;
means for maintaining the state of implementation of the variable update in the appliance; and
means for restoring the pre-update variable value in said directory, using a replication message sent to said directory, and providing an error message to other systems, if the appliance update is unsuccessful.

17. The system according to claim 16, wherein the agent is a client of SNMP, SSH, or LDAP.

18. A directory-based service activation system for automatically updating, in relatively real time, information regarding a variable in an appliance running an agent forming a client of a TCP/IP protocol, while maintaining the pre-update state of the variable at least until the update is successful, wherein the directory activation service system in a networked environment comprises:
a primary directory;
a secondary directory;
a change detector;
an activation engine;
a filter list;
a collate list;
an application program interface;
device drivers; and
devices.

19. A computer implemented method of updating a local record of a variable in an appliance comprising an agent forming a client of SNMP, SSH, LDAP or any other TCP/IP protocol on a telecommunications network, said primary directory service being configured to store and distribute information related to managing said telecommunications network including data on resources available on said telecommunications network and said variable relating to a portion of the network information and being maintained in a directory of said primary directory service, the method comprising:
at the primary directory service, establishing a replication request for the variable with respect to said appliance establishing a replicating session to a secondary directory service;
operating the primary directory service to identify a change in the variable at the primary directory service; responding to the change to said variable by issuing a replication message to the secondary directory service;
the secondary directory service receives the replication message from said primary directory service in respect of a change to said variable;
the secondary directory service responds to said replication message by storing both the old (pre-replication) and new (post-replication) values of the said variable in the appliance;
the secondary directory service sends a message to the agent on the client about the new data using the supported said agent protocol and then;
upon receiving a message from the agent about the execution state of the change due to new data;
swapping dropping the old data with the new data, if the received message by said secondary server indicates success, otherwise,
keeping the old data and sending a replication modification message back to the primary directory service to swap replace the new data with old data.

20. The method of claim 19, wherein the replication session and messages include changes for a set of variables used with a single appliance.

21. The method of claim 19, wherein the secondary directory service collects a set of replication messages into a “batch” and treats the batch as a single entity when determining activation and sending the modification request on failure.

22. The method of claim 19, wherein the replication session and messages include changes for a set of variables used across the set of appliances.

23. The method of claim 19, wherein establishing a replication request for the variable with respect to said appliance comprises establishing a filter for variables manually by an operator, wherein the filter directs the replication message to said directory user agent of said appliance.

24. The method of claim 19, wherein said establishing a replication request for the variable with respect to said appliance comprises establishing a filter automatically in response to a request from said appliance, wherein the filter directs the replication message to the secondary directory Service.

25. The method according to claim 19, wherein said replication message is an LDAP replication message.
